(19) United States
(12) Patent Application Publication
(10) Pub. No.: US 2017/0084152 A1
(43) Pub. Date: Mar. 23, 2017

(54) System and Method for Providing a Caretaker Reminder using a Caretaker Reminder Application

(71) Applicant: Afflatus Products, LLC, Scottsdale, AZ (US)

(72) Inventor: Alex Wolfram, Scottsdale, AZ (US)

(21) Appl. No.: 14/861,612

(22) Filed: Sep. 22, 2015

(51) Int. Cl. G08B 21/02; G08B 25/01; G08B 21/24

(52) U.S. Cl. CPC G08B 21/0277; G08B 21/24; G08B 25/016

(57) ABSTRACT

This disclosure relates to a system and method for providing a caretaker reminder application. A caretaker reminder system can comprise a Bluetooth transceiver, a device memory, and a device processor. The device memory can store an alert and a caretaker reminder application. The device processor can, according to the instruction from the caretaker reminder application provide, upon connecting by the Bluetooth transceiver to a dedicated Bluetooth beacon mountable to an auxiliary power outlet, a graphical user interface viewable to a user on a display. The graphical user interface can provide the user an option to put the caretaker reminder application in a monitoring mode. Additionally, the device processor can, alert the user when the Bluetooth transceiver loses connection with the dedicated Bluetooth beacon if the caretaker reminder application is in the monitoring mode.

### BACKGROUND

This disclosure relates to a system and method for providing a caretaker reminder using a Caretaker Reminder Application.

Incidents of child being left in a car have been a common cause of numerous deaths to children. A caretaker such as a parent or babysitter is left with the responsibility of providing wellbeing to a child. However, there are scenarios wherein a caretaker's routines are changed or a caretaker might be pre-occupied with other things, such as work, and chores, which causes the caretaker to forget that she is travelling with a child, especially when a child is sleeping. In such scenario, upon arriving at a destination the caretaker may go about her business and leave the car while completely forgetting that a child is still inside. According to the National Traffic Highway Safety Administration,
“Cars parked in direct sunlight can reach internal temperatures up to 131° F.-172° F. (55° C.-78° C.) when outside temperatures are 80° F.-100° F. (27° C.-38° C.). Even outside temperatures in the 60s can cause a car temperature to rise well above 110° F. (43° C.). When the outside temperature is 83° F. (28° C.), even with the window rolled down 2 inches, the temperature inside the car can reach 109° F. (43° C.) in only 15 minutes. Within the first 10 minutes the temperature in an enclosed vehicle will rise an average of 19 degrees Fahrenheit (11 degrees Celcius) or 82 percent of its eventual one-hour rise. In warm weather, a vehicle can warm to dangerous, life-threatening levels in only 10 minutes.”

Providing a caretaker with a consistent, reliable reminder about the presence of an infant could ultimately save lives. As such it would be useful to have an improved system and method for providing a caretaker a reminder.

### SUMMARY

This disclosure relates to a system and method for providing a caretaker reminder. A caretaker reminder system can comprise a Bluetooth transceiver, a device memory, and a device processor. The device memory can store an alert and a caretaker reminder application. The device processor can, according to the instruction from the caretaker reminder application provide, upon connecting by the Bluetooth transceiver to a dedicated Bluetooth beacon mountable to an auxiliary power outlet, a graphical user interface viewable to a user on a display. The graphical user interface can provide the user an option to put the caretaker reminder application in a monitoring mode. Additionally, the device processor can, alert the user when the Bluetooth transceiver loses connection with the dedicated Bluetooth beacon if the caretaker reminder application is in the monitoring mode.

This disclosure also relates to a method for providing a caretaker reminder using a caretaker reminder application. The method can comprise the step of providing, upon connecting by a Bluetooth transceiver to a dedicated Bluetooth beacon mountable to an auxiliary power outlet, a graphical user interface viewable to a user on a display, the graphical user interface viewable to a user on a display. The graphical user interface can provide the user an option to put the caretaker reminder application in a monitoring mode. Furthermore, the method can also comprise the step of alerting the user when the Bluetooth transceiver loses connection with the dedicated Bluetooth beacon if the caretaker reminder application is in the monitoring mode.

Lastly, the system can comprise a non-transitory computer readable storage medium having a computer readable program code embodied therein. The computer readable program code can be adapted to be executed to implement the above-mentioned method.

### BRIEF DESCRIPTION OF THE DRAWINGS

FIG. 1 illustrates a caretaker reminder system comprising a proximity monitoring system, and a mobile device connected via a Bluetooth network.

FIG. 2A illustrates internal components of a proximity monitoring system comprising a Bluetooth beacon.

FIG. 2B illustrates an embodiment of a dedicated proximity monitoring system.

FIG. 3 illustrates internal hardware of a mobile device.

FIG. 4 illustrates a mobile device memory.

FIG. 5 illustrates device data storage.

FIG. 6 illustrates a configuration screen.

FIG. 7 illustrates a message screen.

FIG. 8 illustrates an embodiment of a graphical user interface comprising a confirmation message that allows a user an option to put caretaker reminder application in a monitoring mode.

FIG. 9 illustrates an embodiment of an alert comprising alert message and an acknowledgement button.

FIG. 10 illustrates an exemplary method of notifying a user that the user is travelling on a car with a child.

### DETAILED DESCRIPTION

Described herein is a system and method for providing a caretaker reminder application. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

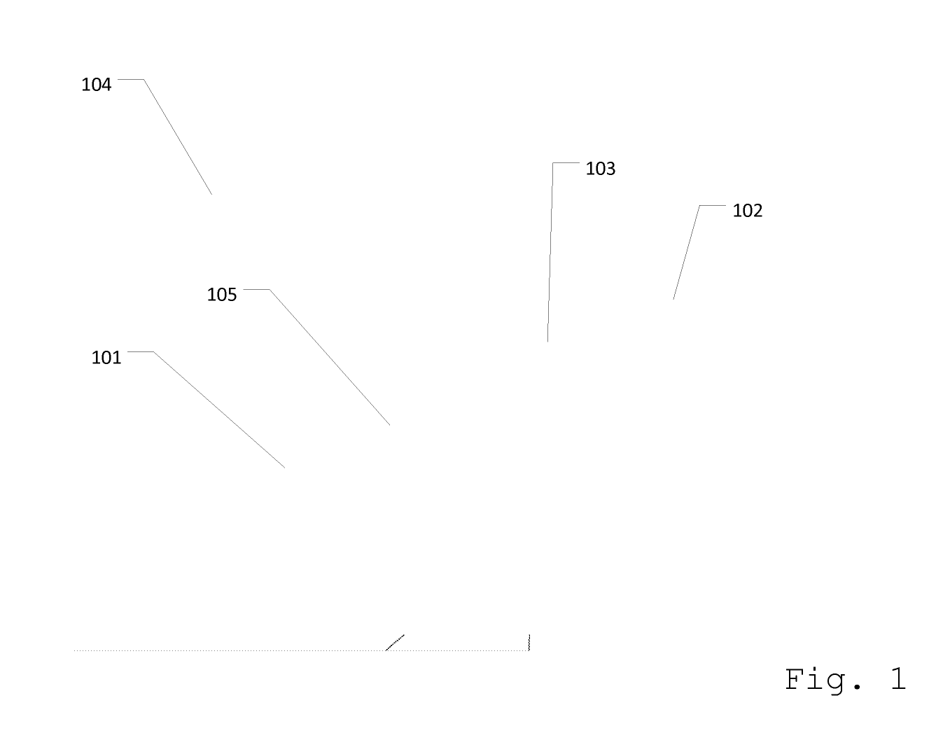

FIG. 1 illustrates a caretaker reminder system comprising a proximity monitoring system 101, and a mobile device 102 connected via a Bluetooth network 103. The caretaker reminder system can be used to notify a user that he is travelling on a car 104 with a child. In this system, proximity monitoring system 101 can be plugged in and powered by an auxiliary power outlet 105 of car 104. Auxiliary power outlet 105 can be a 12V power outlet on car 104, such as a cigarette lighter receptacle. Proximity monitoring system 101 can be capable of transmitting a signal to mobile device 102. This can allow mobile device 102 to determine the mobile device proximity to proximity monitoring system 101. Mobile device 102 can include, but is not limited, to a mobile phone, a smart watch, a personal digital assistant (PDA), and/or tablet. Bluetooth network 103 is commonly referred to as a piconet.

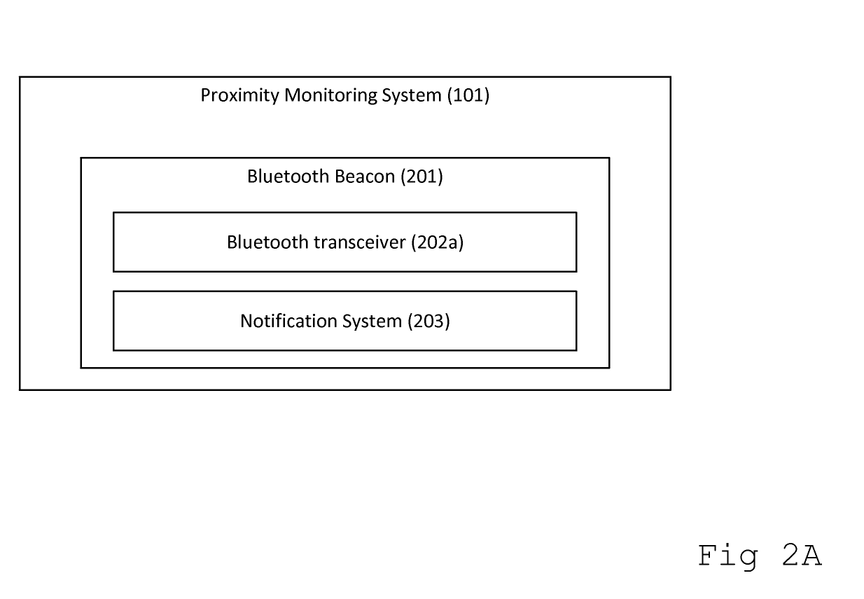

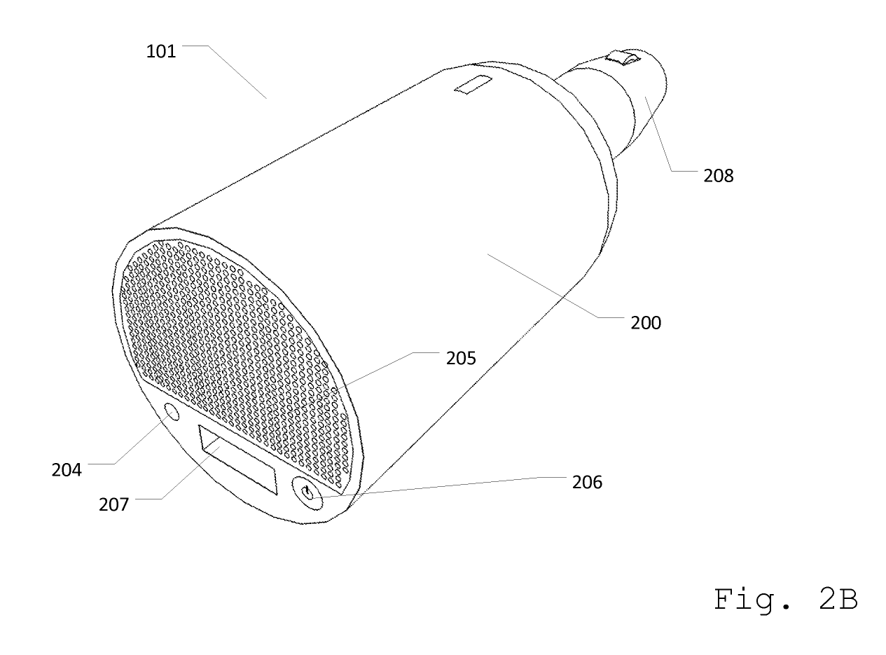

FIG. 2A illustrates internal components of proximity monitoring system 101 comprising a Bluetooth beacon 201. Bluetooth beacon 201 can comprise a Bluetooth transceiver 202, and a Notification system 203 in one embodiment. Bluetooth transceiver 202a can be capable of transmitting and receiving a Bluetooth signal. Notification system 203 can be capable of recognizing when mobile device 102 is within range of proximity monitoring system 101 and communicate such information to a user.

FIG. 2B illustrates an embodiment of a dedicated proximity monitoring system 101. Proximity monitoring system 101 can comprise a casing 200. Additionally, notification system 203 of proximity monitoring system 101 can comprise an indicator 204 and/or a speaker 205. Bluetooth beacon 201 can comprise one or more buttons 206 such as an ON/OFF button that allows a user to turn Bluetooth beacon 201 on or off Proximity monitoring system 101 can further comprise, one or more powered ports 207, and a plug 208. Casing 200 can be a solid body in various shapes and/or sizes. Casing 200 can house indicator 204, speaker 205, buttons 206, and powered ports 207. Indicator 204 can be mounted on casing 200. Indicator 204 can comprise a light-emitting diode (LED). Indicator 204 can be used to indicate that proximity monitoring system 101 is powered on. Furthermore, indicator 204 can use different colors to indicate status of proximity monitoring system 101. Indicator 204 can use blinking lights to indicate that proximity monitoring system 101 is trying to establish a connection with other devices. Furthermore, a steady light can indicate that connection has been established with a device. Speaker 205 can mount within casing 200 and capable of generating sounds to notify user that Bluetooth beacon 201 is active or inactive. Moreover, speaker 205 can be capable of generating sounds to indicate status of proximity monitoring system 101. In one embodiment, the sounds generated can be a series of different tones and/or beeps. In one embodiment, buttons 206 can comprise of on and/or off, and reset button. In another embodiment, buttons 206 can further comprise a volume button. Powered ports 207 can be capable of charging mobile devices. As such, powered ports 207 can be different type of connectors, which can include but is not limited to USB connector, micro-USB connector, mini-USB B plug, and/or lightning connector. Powered ports 207 can be used concurrently with proximity monitoring system 101, and can allow mobile device 102 to charge. Plug 208 can be mounted at the opposite end of casing 200. Plug 208 can be a 12V power plug that is compatible with auxiliary power outlet 105 of car 104.

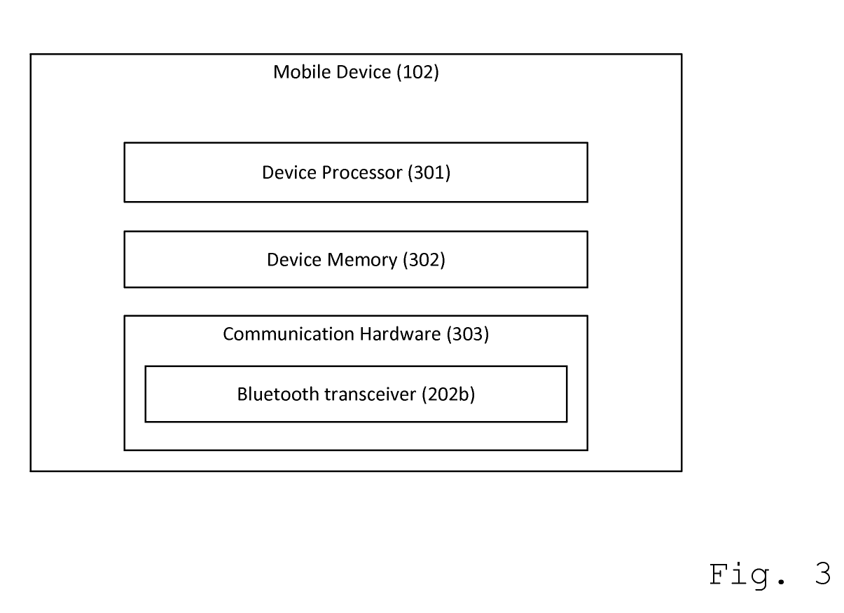

FIG. 3 illustrates internal hardware of mobile device 102. Mobile device 102 can comprise a device processor 301, a device memory 302, and communication hardware 303. Device processor 301 can be a device that performs executable functions on device memory 302. Device memory 302 can be a physical device used to store programs and/or data. Communication hardware 303 can include a network transport processor for packetizing data, communication ports for wired communication, or an antenna for wireless communication. Communication hardware 303 can comprise a Bluetooth transceiver 202b. Bluetooth transceiver 202b on mobile device 102 can be capable of transmitting and receiving communication with Bluetooth device 202a in proximity monitoring system 101.

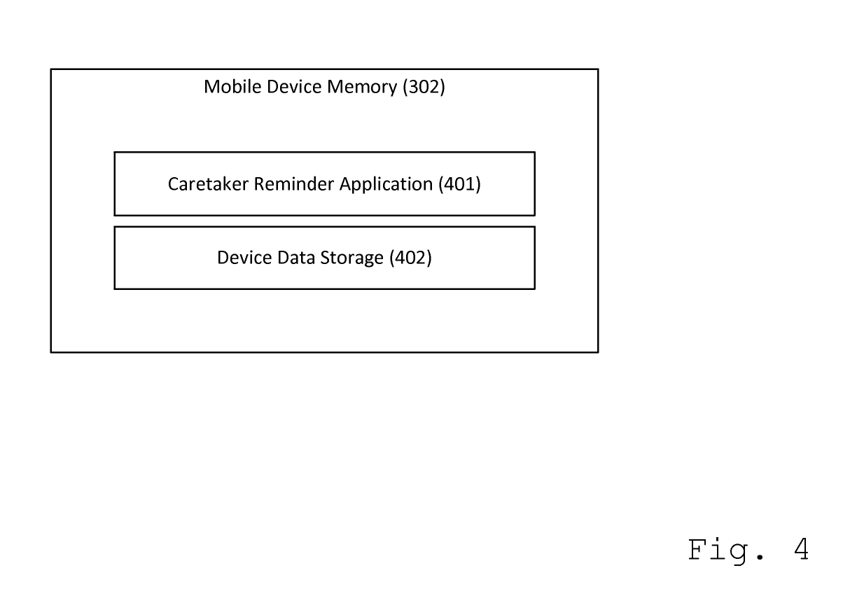

FIG. 4 illustrates mobile device memory 302. Mobile device memory 302 can comprise a caretaker reminder application 401 and device data storage 402. Caretaker reminder application 401 can reside and perform logical functions within mobile device memory 302. Caretaker reminder application 401 can receive and transmit sets of instructions and data information across network 103. Device data storage 402 can be a component in mobile device memory 302 that can be used to retain digital data. Furthermore, mobile device processor 301 can perform processes on the data according to a caretaker reminder application 401 stored in mobile device memory 302.

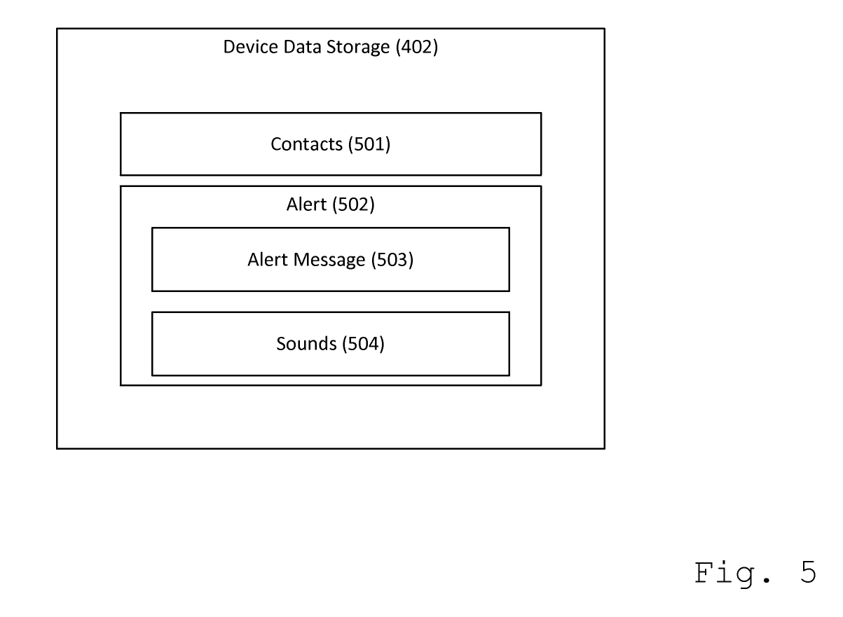

FIG. 5 illustrates device data storage 402 comprising contacts 501 and an alert 502. Alert 502 can comprise an alert message 503, and/or one or more sounds 504. Alert message 503 can be the text displayed on mobile device 102 once alert 502 is triggered. In one embodiment, alert message 503 can be a preset message that informs a user that the user is travelling with a child. In another embodiment, the user can customize alert message 503. Sounds 504 can be the sound played once alert 502 is triggered. Sounds 504 can comprise a plurality of preset sounds, which can include beeps, tones, and voice recordings. In one embodiment, the user can customize a sound 504. In one embodiment, the user can use own voice recording. In another embodiment, the user can choose preferred audio file by using mobile device 102 ringtones or by downloading an audio such as .mp3, .mp4 files.

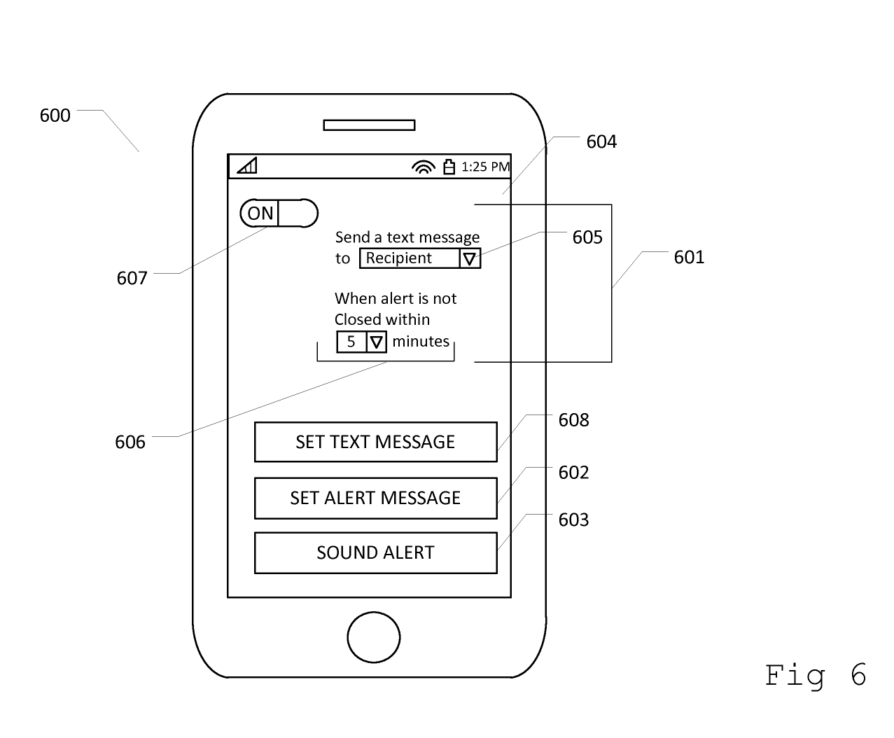

FIG. 6 illustrates a configuration screen 600. In one embodiment, configuration screen 600 can comprise a text message option 601, a set alert message button 602, and a set sound alert button 603. Text message option 601 can allow a user to send a text message 604 to a specific recipient 605 in contacts 501 when alert 502 is not closed within a time period 606. In one embodiment, text message option can be enabled and disabled by clicking an enable text option button 607.

In one embodiment text message 604 can be pre-determined. In another embodiment, a user can customize text message 604 by clicking set text message button 608.

Recipient 605 can be a contact person to be notified when alert 502 is not terminated within time period 606. In one embodiment, time period 606 can be determined. In another embodiment, the user can set time period 606 for alert 502. Set alert message button 602 can allow a user to customize alert message 503. Set sound alert button 603 can allow user to select sound 504.

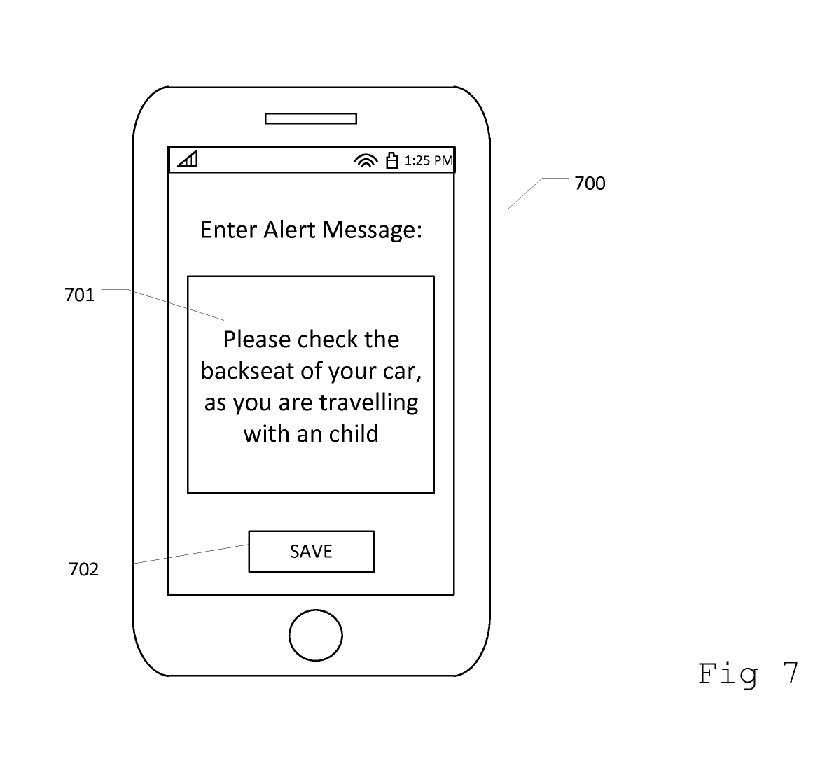

FIG. 7 illustrates a message screen 700. When a user clicks on set alert message button 602, the user is brought to message screen 700. Message screen 700 can allow user to enter a desired alert message 503. Message screen 700 can comprise a text field 701 and a save button 702. Text field 701 can allow user to enter the alert message that will appear on the user's mobile device 102. After entering a desired alert message on text field 701, the user can click save button 702 to save the entered alert message 503

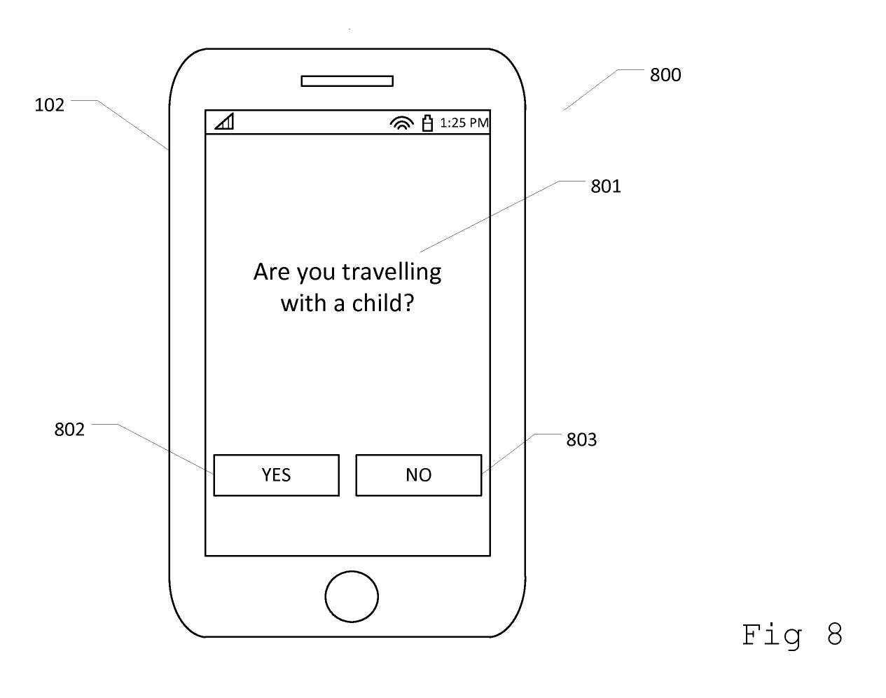

FIG. 8 illustrates an embodiment of graphical user interface 800 comprising a confirmation message 801 that allows a user an option to put caretaker reminder application 401 in a monitoring mode, such as a “Yes” button 802, and a “No” button 803. Graphical user interface 800 can display in the screen of mobile device 102, when Bluetooth transmitter 202a connects with Bluetooth transmitter 202b. As an example shown in FIG. 8, graphical user interface 800 can display confirmation message 801 to verify if the user is travelling on car 104 with a child. If the user is travelling with a child then the user can click yes button 802, but if the user is not travelling with a child the user can click no button 803. Clicking yes button 802 can place caretaker reminder application 401 in a monitoring mode.

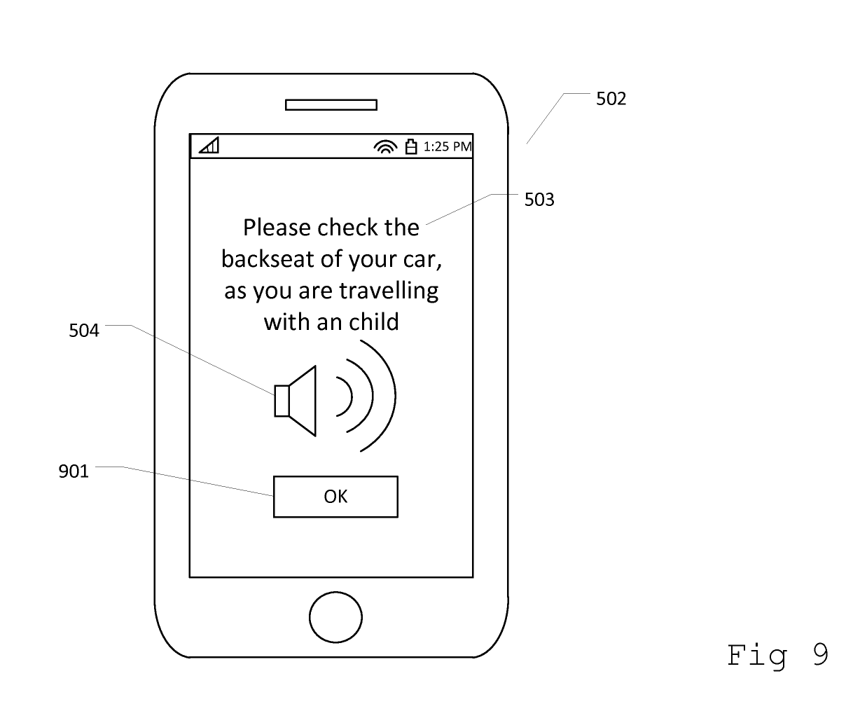

FIG. 9 illustrates an embodiment of alert 502 comprising alert message 503 and an acknowledgement button 901. In a scenario wherein a user is travelling with a child and connection between proximity monitoring system 101 and mobile device 102 is lost, alert 502 can be triggered on mobile device 102. As such, alert message 503 can be displayed on the screen of mobile device 102 to notify user to check if a child is left inside car 104. In one embodiment, sounds 504 can be played concurrently as alert message 503 is displayed on mobile device 102. Clicking acknowledgement button 901 can terminate alert 502 and/or stop sounds 504 from playing. In an embodiment wherein text message option 601 is enabled, when alert 502 is closed within time period 606, text message 604 will not be sent to recipient 605. However, in such embodiment, if alert is not closed, text message 604 will be sent to recipient 605.

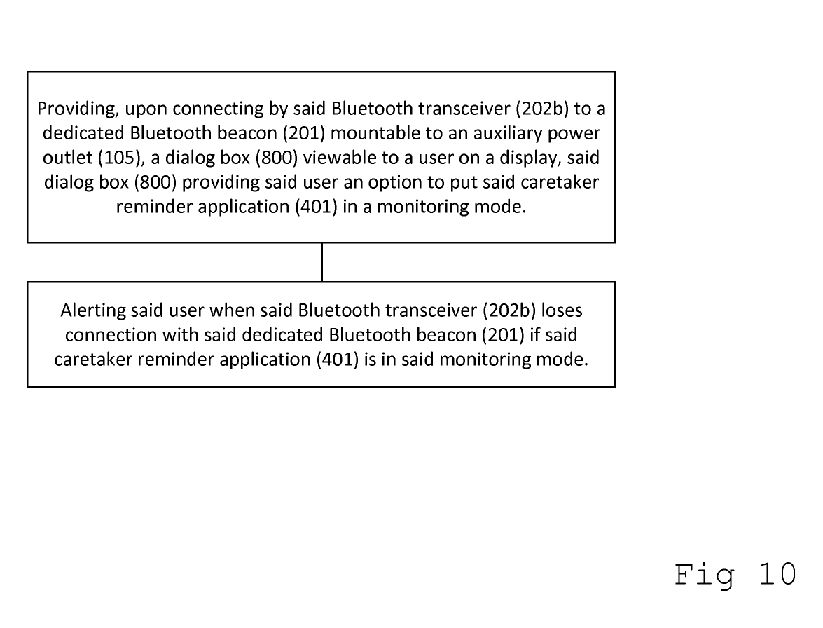

FIG. 10 illustrates an exemplary method of notifying a user that the user is travelling on car 104 with a child. Initially, the user can access configuration screen 600 to customized alert 502 on caretaker reminder application 401. As such, the user can enter alert message 503 to be displayed, and select sounds 504 to be played, whenever alert 502 is triggered.

Whether using customized alert 502 or general alert 502, the system works in the following manner. User can connect proximity monitoring system 101 into auxiliary power outlet 105. When connected, proximity monitoring system 101 becomes energize, and can transmit a signal. Alternatively, some vehicles only power auxiliary power outlet 105 when the vehicle is started. In such embodiment, when a user starts the engine of car 104, proximity monitoring system 101 automatically turns on and transmits a signal. Once on, proximity monitoring system 101 can pair with the user's mobile device 102. In one embodiment, as soon as proximity monitoring system 101 is turned on, proximity monitoring system 101 can, in one embodiment, turn on a light or make a sound to show that such connection has been made. Concurrently, mobile device 102 with caretaker reminder application 401 can receive the signal transmitted by proximity monitoring system 101 and establishes a connection. Once mobile device 102 is recognized, graphical user interface 800 can be displayed. The user can either click yes button 802 to put caretaker reminder application 401 in monitoring mode, or click no button 803 to terminate caretaker reminder application 401. At an active state, caretaker reminder application 401 can monitor the signal connection between mobile device 102 and proximity monitoring system 101. Alert 502 can be triggered once signal connection between mobile device 102 and proximity monitoring system 101 is lost. In one scenario wherein auxiliary power outlet 105 can be powered on even when car engine is turned off, when the user carrying mobile device 102 walks away from car 104 comes out of range from proximity monitoring system 101, alert 502 can be triggered. In another scenario, auxiliary power outlet 105 is powered off once car engine is turned off, the lost of connection on proximity monitoring system 101 can cause caretaker reminder application 401 to trigger alert 502.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A caretaker reminder system comprising
a Bluetooth transceiver;
a device memory that stores
an alert; and
a caretaker reminder application; and
a device processor that, according to the instructions from said caretaker reminder application
provides, upon connecting by said Bluetooth transceiver to a dedicated Bluetooth beacon mountable to an auxiliary power outlet, a graphical user interface viewable to a user on a display, said graphical user interface providing said user an option to put said caretaker reminder application in a monitoring mode;
alerts said user with an alert when said Bluetooth transceiver loses connection with said dedicated Bluetooth beacon if said caretaker reminder application is in said monitoring mode.

2. The system of claim 1 wherein said Bluetooth transceiver loses connection with said dedicated Bluetooth beacon when said auxiliary power outlet stops providing power to said dedicated Bluetooth beacon.

3. The system of claim 1 wherein said Bluetooth transceiver loses connection with said dedicated Bluetooth beacon when said Bluetooth transceiver is out of range of said Bluetooth beacon.

4. The system of claim 1 wherein said alert comprises an alert message.

5. The system of claim 4 wherein said alert message is a customized message.

6. The system of claim 1 wherein said alert comprises a sound.

7. The system of claim 6 wherein said sound comprises a voice recording.

8. The system of claim 1 wherein said caretaker reminder application runs on a mobile phone.

9. The system of claim 1 wherein said caretaker reminder application runs on a smart watch.

10. The system of claim 1 wherein said caretaker reminder application runs on a personal digital assistant (PDA).

11. The system of claim 1 wherein said caretaker reminder application runs on a tablet.

12. A method for providing a caretaker reminder application comprising the steps of
providing, upon connecting by a Bluetooth transceiver to a dedicated Bluetooth beacon mountable to an auxiliary power outlet, a graphical user interface viewable to a user on a display, said graphical user interface providing said user an option to put said caretaker reminder application in a monitoring mode;
alerting said user with an alert when said Bluetooth transceiver loses connection with said dedicated Bluetooth beacon if said caretaker reminder application is in said monitoring mode.

13. The method of claim 12 further comprising the step of customizing said alert on said mobile device.

14. The method of claim 14 wherein said alerting said user comprises displaying a message on a display.

15. The method of claim 14 wherein said alerting said user comprises playing a sound.

16. The method of claim 14 further comprising transmitting a text to a recipient if said user does not respond to said alert

17. A non-transitory computer readable storage medium having a computer readable program code embodied therein, wherein the computer readable program code is adapted to be executed to implement the method of claim 1.
